(19) United States
(12) Patent Application Publication
(10) Pub. No.: US 2025/0149706 A1
(43) Pub. Date: May 8, 2025

(54) BATTERY PACK STRUCTURE FOR VEHICLE

(71) Applicants: HYUNDAI MOTOR COMPANY, SEOUL (KR); KIA CORPORATION, SEOUL (KR)

(72) Inventors: Gyung Hoon Shin, Seoul (KR); Jong Gyu Park, Hwaseong-si (KR); Gun Woo Ko, Seongnam-si (KR); Hae Woong Jung, Anyang-si (KR)

(21) Appl. No.: 18/610,794

(22) Filed: Mar. 20, 2024

(30) Foreign Application Priority Data
Nov. 8, 2023 (KR) 10-2023-0153623

(51) Int. Cl. H01M 50/242; H01M 50/249; H01M 50/645

(52) U.S. Cl. CPC H01M 50/242; H01M 50/249; H01M 50/645; H01M 2220/20

(57) ABSTRACT

A battery pack structure for a vehicle includes a outer member having as elongated shape and positioned along an outer part of a battery casing, the outer member having a hollow cross section, and a member reinforcement part provided at a partial section of the outer member and formed by filling a structural foam into a hollow part in the section of the outer member.

### CROSS REFERENCE TO RELATED APPLICATIONS

The present application claims priority to Korean Patent Application No. 10-2023-0153623, filed Nov. 8, 2023, the entire contents of which is incorporated herein for all purposes by this reference.

### BACKGROUND

### 1. Technical Field

The present disclosure relates to a battery pack structure for a vehicle.

### 2. Description of the Related Art

Electric vehicles are equipped with a battery pack to supply power to a motor that provides a driving force to a vehicle.

The battery pack includes a plurality of battery modules, and a battery casing receiving and enveloping the battery modules. Each of the battery modules consists of a plurality of battery cells.

The battery casing includes a lower casing and an upper cover that envelop the battery modules, and usually the battery casing is mounted to a lower portion of the vehicle body.

Preferably, the battery pack configured as described above may be equipped with as many battery modules as possible so that a cruising range of a vehicle increases.

Meanwhile, the battery pack should have sufficient hardness so that same that can safely protect the battery modules in situations such as vehicle collision accidents, and a plurality of reinforcing materials is used to the battery pack to this end, carrying capacity of the battery modules tends to be relatively reduced.

The description provided above as a related art of the present disclosure is just for helping understand the background of the present disclosure and should not be construed as being included in the related art known by those skilled in the art.

### SUMMARY

The present disclosure is intended to provide a battery pack structure for a vehicle, wherein the battery pack structure is configured to allow battery modules to be mounted as much as possible to a battery pack mounted to a vehicle and sufficiently ensure hardness of the battery pack to contribute to increasing of a cruising range of electric vehicles, and which is configured to efficiently protect the battery modules received in the battery pack.

Another objective of the present disclosure is to provide a battery pack structure for a vehicle, wherein the battery pack structure is configured to minimize a mounted part when a battery pack is mounted to a lower part of a vehicle to allow rapid disassembly and assembly, and to sufficiently ensure structural hardness of the battery pack mounted to the vehicle.

In order to achieve the above-mentioned objective, according to the present disclosure, there is provided a battery pack structure for a vehicle, the battery pack structure including an outer member provided in a long shape along an outer part of a battery casing while having a hollow cross section, and a member reinforcement part provided at a partial section of the outer member and formed by filling a structural foam into a hollow part in the section of the outer member. The member reinforcement part may include a partition plug, which is inserted into the outer member, so as to partition the section of the outer member where the structural foam is filled.

The partition plug may include a partition wall blocking the hollow part of the outer member, and a fixation rib fixing the partition plug to the outer member.

The the partition wall may be formed to be inserted perpendicular to a longitudinal direction of the outer member, and the fixation rib may be formed to be inserted parallel to the longitudinal direction of the outer member.

The fixation rib may have a bolt through hole to allow a fastening bolt to pass through the bolt through hole to penetrate through and be fastened to the outer member.

The partition plug may have a form in which the partition wall and the fixation rib form walls perpendicular to each other, and the outer member may have a plug hole into which the partition plug is inserted.

The partition plug may include a cover part, the cover part covering an outer portion of the plug hole while the partition wall and the fixation rib are inserted into the plug hole.

The cover part of the partition plug may include a gasket to seal a gap between the cover part and the outer member.

A plurality of partition plugs may be inserted into the outer member so as to provide opposite ends of the member reinforcement part, and the outer member may have an injection hole to inject the structural foam between the plurality of partition plugs.

The outer member may be formed in forward and rearward directions along a side surface of the battery casing, with a long shape, and the member reinforcement part may be located at a central portion of the side surface of the battery casing.

The battery casing may include a lower casing and an upper cover, the outer member may have a cross-sectional shape including a vertical part and a horizontal part, and providing a side surface of the lower casing, and the horizontal part may protrude sideways from the lower casing.

The member reinforcement part may be provided in the horizontal part of the outer member.

The horizontal part of the outer member may have mounting holes at locations spaced respectively forwards and rearwards from the member reinforcement part, the mounting holes being provided to mount a battery pack to a vehicle body.

A front wall member may be positioned at a front portion of the lower casing, the front wall member being connected to a front end of the outer member, a rear wall member may be provided at a rear portion of the lower casing, the rear wall member being connected to a rear end of the outer member, and the outer member may have mounting holes at a location spaced apart from the member reinforcement part and adjacent to the front wall member and at a location spaced apart from the member reinforcement part and adjacent to the rear wall member, and the mounting holes being provided to mount a battery pack to a vehicle body.

Furthermore, in order to achieve the above-mentioned objective, according to the present disclosure, there is provided a battery pack structure for a vehicle, the battery pack structure including an outer member providing a side surface of a lower casing receiving a battery module, a member reinforcement part formed by filling a structural foam into a partial section of the outer member, and mounting holes provided on the outer member while being spaced respectively forwards and rearwards from the member reinforcement part, and provided to mount the lower casing to a vehicle body.

The battery pack structure may include a front wall member connected to a front end of the outer member, and surrounding a front portion of the lower casing, and a rear wall member connected to a rear end of the outer member, and surrounding a rear portion of the lower casing, wherein the member reinforcement part may be provided at a maximally spaced location from both of the front wall member and the rear wall member, and the mounting holes may be provided at locations adjacent to both of the front wall member and the rear wall member.

The outer member may have a hollow cross section consisting of a vertical part surrounding a side surface of the lower casing and a horizontal part protruding outwards from the vertical part, the vertical part and the horizontal part being integrated with each other, and the member reinforcement part may be provided in the horizontal part of the outer member.

A partition plug may be positioned in the horizontal part of the outer member and be configured to limit a flow range of the structural foam when the structural foam forming the member reinforcement part is injected.

The partition plug may include a partition wall blocking a hollow part in the horizontal part so as to limit the flow range of the structural foam, and a fixation rib integrally connected to the partition wall to fix the partition wall, wherein a fastening bolt may be fastened to the horizontal part of the outer member and fixes the fixation rib.

The partition plug may have a cover part to cover a plug hole formed in the horizontal part to allow the partition wall and the fixation rib to be inserted.

The present disclosure can allow as many battery modules as possible to be mounted to the battery pack mounted to the vehicle and sufficiently ensure hardness of the battery pack to contribute to increasing of the cruising range of electric vehicles, and the present disclosure can efficiently protect the battery modules received in the battery pack.

The present disclosure can minimize a mounted part when the battery pack is mounted to the lower part of the vehicle to allow rapid disassembly and assembly, and to sufficiently ensure structural hardness of the battery pack mounted to the vehicle.

### BRIEF DESCRIPTION OF THE FIGURES

FIG. 1 is a plane view showing a battery pack structure for a vehicle according to the present disclosure;

FIG. 2 is a detailed view showing a member reinforcement part of an outer member of FIG. 1;

FIG. 3 is a sectional view taken along line III-III in FIG. 2;

FIG. 4 is a view showing a partition plug;

FIG. 5 is a view showing an outer member before the partition plug is inserted;

FIG. 6 is a view showing a state in which the partition plug is inserted into the outer member shown as FIG. 5;

FIG. 7 is a view showing a structure in which the partition plug is fixed to the outer member;

FIG. 8 is a cross-sectional view taken along line VIII-VIII in FIG. 1, and the view showing an example of a portion where a battery pack of the present disclosure is coupled to the vehicle body.

### DETAILED DESCRIPTION

In the following description, if it is decided that the detailed description of known technologies related to the present disclosure makes the subject matter of the embodiment described herein unclear, the detailed description is omitted. Furthermore, the accompanying drawings are provided only for easy understanding of the embodiment disclosed in the specification, and the technical spirit disclosed in the specification is not limited by the accompanying drawings, and all changes, equivalents, and replacements should be understood as being included in the spirit and scope of the present disclosure.

Hereafter, an embodiment of the present disclosure will be described in detail with reference to the accompanying drawings and the same or similar components are given the same reference numerals regardless of the numbers of figures and are not repeatedly described.

The suffixes “module” and “part” for the components used in the following description are given or mixed in consideration of only the ease of writing the specification, and do not have distinct meanings or roles by themselves.

In the following description, if it is decided that the detailed description of known technologies related to the present disclosure makes the subject matter of the embodiment described herein unclear, the detailed description is omitted. Furthermore, the accompanying drawings are provided only for easy understanding of the embodiment disclosed in the specification, and the technical spirit disclosed in the specification is not limited by the accompanying drawings, and all changes, equivalents, and replacements should be understood as being included in the spirit and scope of the present disclosure.

Terms including ordinal numbers such as “first”, “second”, etc. may be used to describe various components, but the components are not to be construed as being limited to the terms. The terms are used only to distinguish one component from another component.

It is to be understood that when one element is referred to as being “connected to” or “coupled to” another element, it may be connected directly to or coupled directly to another element or be connected to or coupled to another element, having the other element intervening therebetween. On the other hand, it should to be understood that when one element is referred to as being “connected directly to” or “coupled directly to” another element, it may be connected to or coupled to another element without the other element intervening therebetween.

Singular forms are intended to include plural forms unless the context clearly indicates otherwise.

It will be further understood that the terms “comprise” or “have” used in this specification, specify the presence of stated features, steps, operations, components, parts, or a combination thereof, but do not preclude the presence or addition of one or more other features, numerals, steps, operations, components, parts, or a combination thereof.

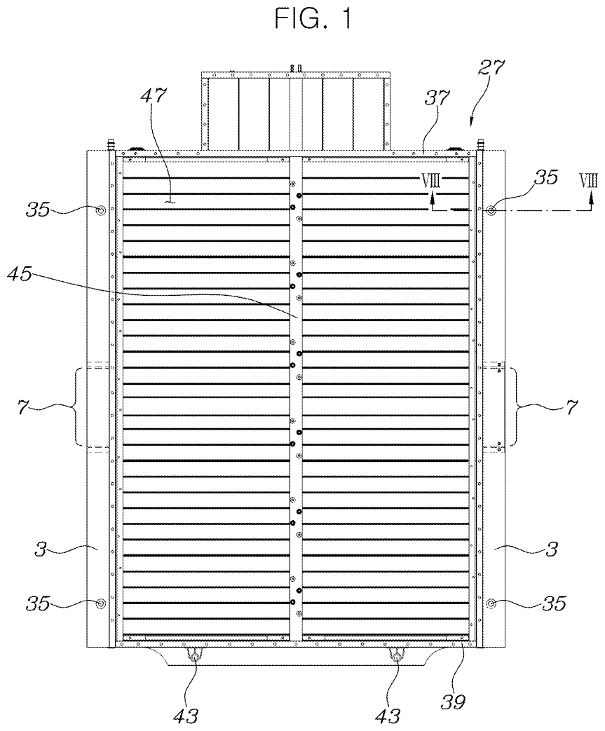

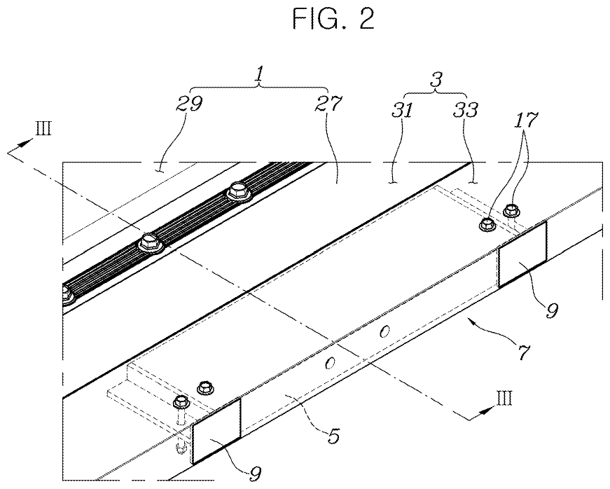

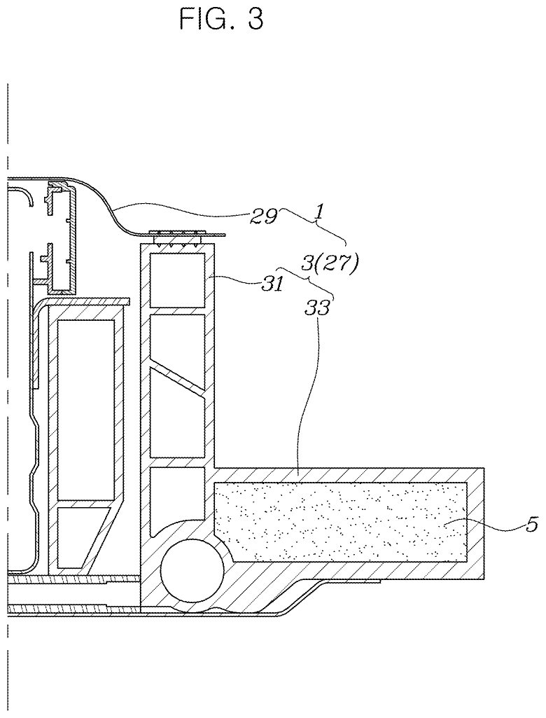

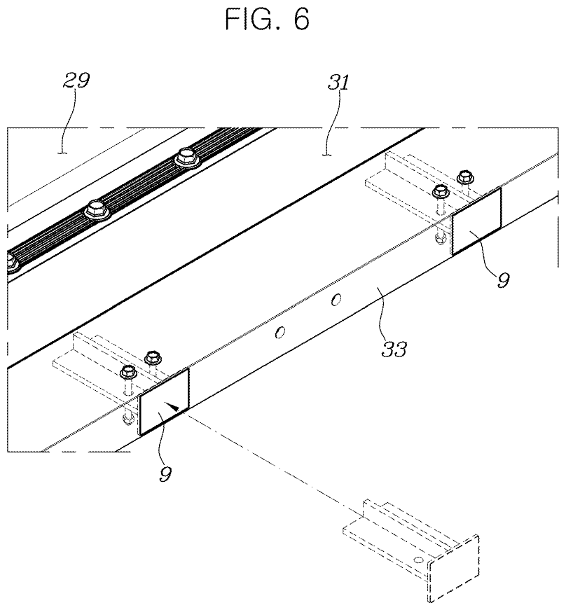

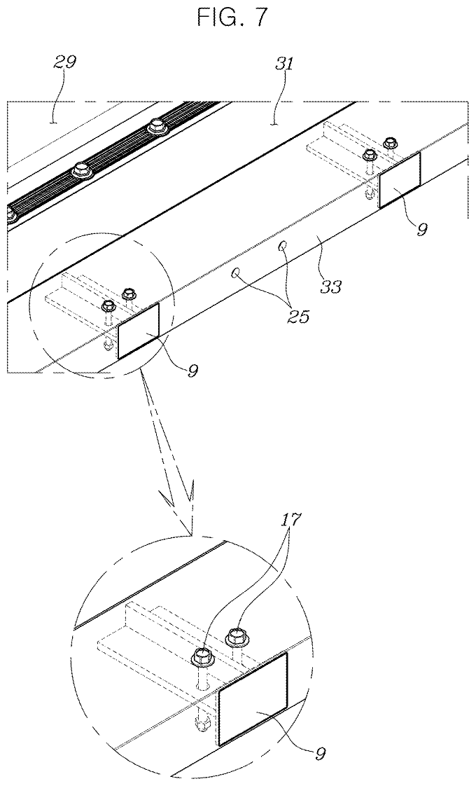

Referring to FIGS. 1 to 8, a battery pack structure for a vehicle according to the present disclosure includes an outer member 3 provided in a long shape along an outer part of a battery casing 1 while having a hollow cross section; and a member reinforcement part 7 provided at a partial section of the outer member 3, and formed by filling a structural foam 5 into a hollow part in the section.

In other words, the battery pack structure of the present disclosure is configured to provide the hollow cross section to the outer member 3 providing the outer part of the battery casing 1, thereby reducing the weight of the battery pack, and which is configured to provide the member reinforcement part 7 filled with the structural foam 5 in the partial section of the outer member 3 to sufficiently ensure structural hardness of the battery pack.

The member reinforcement part 7 includes a partition plug 9 to partition the section of the outer member 3 filled with the structural foam 5, and the partition plug 9 is inserted into the outer member 3.

In other words, the member reinforcement part 7 may include the partition plug 9 and the structural foam 5, the structural foam 5 being filled between the partition plug 9 and another partition plug.

The partition plug 9 includes a partition wall 11 blocking the hollow part of the outer member 3; and a fixation rib 13 fixing the partition plug 9 to the outer member 3.

Therefore, practically, when the structural foam 5 is injected into the outer member 3, the partition wall 11 serves to prevent the structural foam 5 from being moved to other locations and guide the structural foam 5 so that the structural foam 5 is injected into a desired section, and the fixation rib 13 serves to maintain the partition wall 11 firmly fixed.

In the embodiment, the partition wall 11 is formed to be inserted perpendicular to a longitudinal direction of the outer member 3; and the fixation rib 13 is formed to be inserted parallel to the longitudinal direction of the outer member 3.

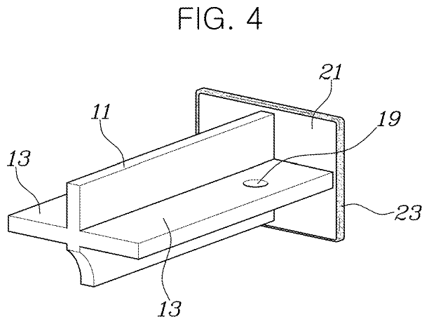

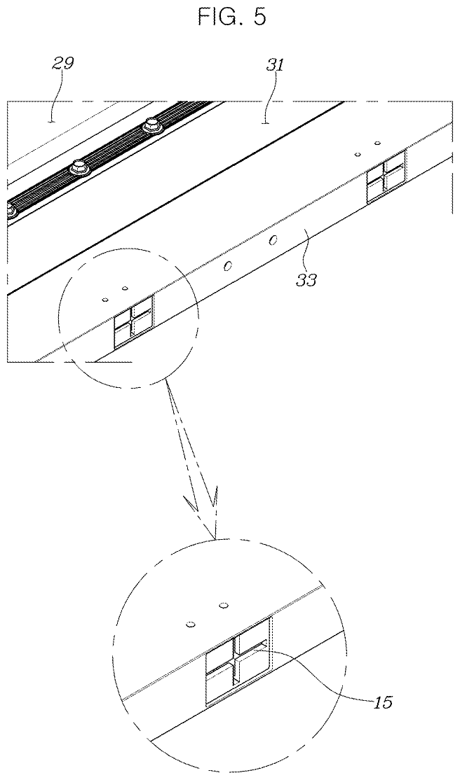

Therefore, as shown in FIG. 4, the partition plug 9 may have a form in which the partition wall 11 and the fixation rib 13 form walls perpendicular to each other, and in this case, the outer member 3 has a plug hole 15 into which the partition plug 9 is inserted, and the plug hole 15 may have a form of a cross-shaped hole as shown in FIG. 5.

Furthermore, the fixation rib 13 has a bolt through hole 19 so that a fastening bolt 17 passes through the bolt through hole 19 to penetrate through and be fastened to the outer member 3.

Therefore, when the fastening bolt 17 is fastened while the partition plug 9 is inserted in the outer member 3, the partition plug 9 is firmly fixed to the outer member 3.

In the embodiment, the partition plug 9 includes a cover part 21, and the cover part 21 surrounds the outer part of the plug hole 15 while the partition wall 11 and the fixation rib 13 are inserted in the plug hole 15.

Therefore, the cover part 21 may prevent foreign substances from penetrating into the outer member 3 via the plug hole 15.

Furthermore, the cover part 21 of the partition plug 9 may have a gasket 23 to seal between the outer member 3 and the cover part 21.

The gasket 23 may be provided along an outer part of the cover part 21 as shown in FIG. 4.

Therefore, the gasket 23 may efficiently prevent moisture, etc. from penetrating into the outer member 3 via the plug hole 15.

In the embodiment, a plurality of partition plugs 9 is inserted into the outer member 3 to provide opposite ends of the member reinforcement part 7; and an injection hole 25 is provided between the plurality of partition plugs 9 of the outer member 3 to inject the structural foam 5.

Therefore, while the partition plugs 9 are provided in the outer member 3, the structural foam 5 is injected into the injection hole 25 to provide the member reinforcement part 7.

For example, the structural foam 5 may use, for example, a foamable epoxy filler, an addition in which other additives are added to a foamable polyurethane filler, and the structural foam 5 may be injected into the hollow part of the outer member 3 via the injection hole 25 and then be foamed and hardened.

Of course, after injection of the structural foam 5 is completed, the injection hole 25 may be sealed with a separate cap, tape, etc.

In the embodiment, the outer member 3 is formed in forward and rearward directions along a side surface of the battery casing 1 while having a long form, and the member reinforcement part 7 is located at a central portion of the side surface of the battery casing 1.

At this point, the battery casing 1 includes a lower casing 27 and an upper cover 29; the outer member 3 has a cross-section form having a vertical part 31 and a horizontal part 33, and provides a side surface of the lower casing 27, and the horizontal part 33 protrudes sideways from the lower casing 27.

In the embodiment, the member reinforcement part 7 is provided in the horizontal part 33 of the outer member 3, but if necessary, a separate member reinforcement part may be added to the vertical part 31.

The horizontal part 33 of the outer member 3 has mounting holes 35 at locations spaced respectively forwards and rearwards from the member reinforcement part 7, and the mounting holes 35 are provided to mount the battery pack to a vehicle body.

In the embodiment, a front wall member 37 is provided at the front of the lower casing 27 and the front wall member 37 is connected to a front end of the outer member 3; and a rear wall member 39 is provided at the rear part of the lower casing 27 and the rear wall member is connected to a rear end of the outer member 3. The mounting holes 35 are respectively formed at the location spaced apart from the member reinforcement part 7 and adjacent to the front wall member 37 and at the location spaced apart from the member reinforcement part 7 and adjacent to the rear wall member 39.

Therefore, the battery pack may be coupled to the vehicle body 41 through the mounting holes 35 formed on four positions at the front and the rear of opposite outer members 3.

Furthermore, in the embodiment, the rear wall member 39 has also two vehicle body mounting parts 43 mounted to the vehicle body 41 so that the mounted state of the battery pack may be firmly ensured, and practically, a separate mounting bracket may be provided at the front of the battery pack to couple the battery pack to the vehicle body.

As described above, the battery pack of the present disclosure is coupled to the vehicle body at a relative small number of locations such as the front part and the rear part of the outer member 3 and the vehicle body mounting parts 43 of the rear wall member 39, thereby allowing rapid disassembly and assembly of the battery pack and the vehicle body 41 to be performed.

Furthermore, as described above, even though there are not many locations where coupling of the battery pack and the vehicle body 41 is performed, the outer member 3 having the member reinforcement part 7 of the present disclosure largely increases side hardness of the battery casing 1, so that effective protection of the battery module received in the battery casing can be possible.

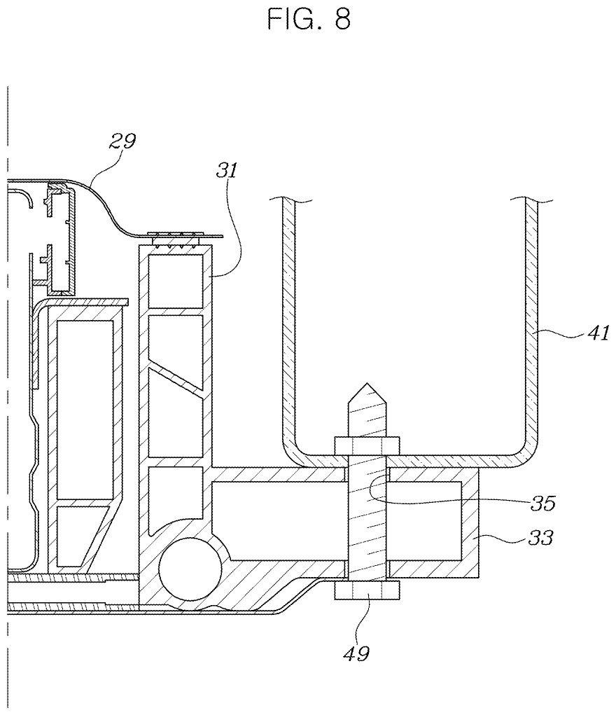

For example, FIG. 8 is a view showing an example of a part coupled to the vehicle body 41 via the mounting holes 35, and the view shows an example in which the mounting bolt 49 is coupled to the vehicle body 41 via the mounting holes 35 formed on the horizontal part 33 of the outer member 3.

Meanwhile, while the battery pack of the present disclosure includes only one longitudinal member 45 therein without a separate transverse member for reinforcing the battery casing 1, as shown in FIG. 1, a remaining space thereof is filled with a battery module 47, so that a cruising range of electric vehicles can increase ultimately. Furthermore, the hardness of the battery casing 1 is sufficiently ensured by the outer member 3 including the member reinforcement part 7 as described above, so that it is possible to efficiently protect the battery module 47 received therein and contribute to improving performance improvement of noise-vibration-harshness (NVH) of a vehicle.

The present disclosure as described above will be expressed as follows.

In other words, the battery pack structure for a vehicle according to the present disclosure includes: the outer member 3 providing the side surface of the lower casing 27 receiving the battery module 47, the member reinforcement part 7 formed by filling the structural foam 5 into a partial section of the outer member 3, and the mounting holes 35 provided on the outer member 3 while being spaced respectively forwards and rearwards from the member reinforcement part 7, and provided to mount the lower casing 27 to the vehicle body.

The lower casing 27 includes the front wall member 37 connected to the front end of the outer member 3, and surrounding the front portion of the lower casing 27, and the rear wall member 39 connected to the rear end of the outer member 3, and surrounding the rear portion of the lower casing 27.

The member reinforcement part 7 is provided at the location maximally spaced apart from both of the front wall member 37 and the rear wall member 39; and the mounting holes 35 are respectively located at the location adjacent to the front wall member 37 and the location adjacent to the rear wall member 39.

The outer member 3 has the hollow cross section consisting of the vertical part 31 and the horizontal part 33 that are integrated with each other, the vertical part 31 surrounding the side surface of the lower casing 27 and the horizontal part 33 protruding outwards from the vertical part 31, and the member reinforcement part 7 is provided in the horizontal part 33 of the outer member 3.

The horizontal part 33 of the outer member 3 includes the partition plug 9, and the partition plug 9 limits the flow range of the structural foam 5 when the structural foam 5 is injected to form the member reinforcement part 7.

The partition plug 9 includes: the partition wall 11 blocking the hollow part in the horizontal part 33 to limit the flow range of the structural foam 5, and the fixation rib 13 integrally connected to the partition wall 11 to fix the partition wall 11. The fastening bolt 17 fixing the fixation rib 13 is fastened to the horizontal part 33 of the outer member 3.

The partition plug 9 includes the cover part 21, and the cover part 21 covers the plug hole 15, which is formed in the horizontal part 33 to allow the partition wall 11 and the fixation rib 13 to be inserted.

Although the present disclosure was provided above in relation to specific embodiments shown in the drawings, it is apparent to those skilled in the art that the present disclosure may be changed and modified in various ways without departing from the scope of the present disclosure, which is provided in the following claims.

1. A battery pack structure for a vehicle, the battery pack structure comprising:
an outer member having an elongated shape and being positioned along an outer part of a battery casing, the outer member having a hollow cross section; and
a member reinforcement part positioned at a partial section of the outer member, and formed by inserting a structural foam into a hollow part in a section of the outer member.

2. The battery pack structure of claim 1, wherein the member reinforcement part comprises a partition plug configured to be inserted into the outer member, so as to partition the section of the outer member where the structural foam is inserted.

3. The battery pack structure of claim 2, wherein the partition plug comprises:
a partition wall blocking the hollow part of the outer member; and
a fixation rib fixing the partition plug to the outer member.

4. The battery pack structure of claim 3, wherein the partition wall is inserted perpendicular to a longitudinal direction of the outer member; and
the fixation rib is inserted parallel to the longitudinal direction of the outer member.

5. The battery pack structure of claim 4, wherein the fixation rib has a bolt through hole configured to allow a fastening bolt to pass through, and to fasten the fixation rib to the outer member.

6. The battery pack structure of claim 4, wherein the partition wall and the fixation rib form walls perpendicular to each other; and
the outer member has a plug hole into which the partition plug is inserted.

7. The battery pack structure of claim 6, wherein the partition plug further comprises a cover part, the cover part covering an outer portion of the plug hole when the partition wall and the fixation rib are inserted into the plug hole.

8. The battery pack structure of claim 7, wherein the cover part of the partition plug comprises a gasket configured to seal a gap between the cover part and the outer member.

9. The battery pack structure of claim 2, wherein a plurality of partition plugs are inserted into the outer member to form opposite ends of the member reinforcement part; and
the outer member has an injection hole configured to receive the structural foam between the plurality of partition plugs.

10. The battery pack structure of claim 1, wherein the outer member is formed in forward and rearward directions along a side surface of the battery casing; and
the member reinforcement part is located at a central portion of the side surface of the battery casing.

11. The battery pack structure of claim 10, wherein the battery casing comprises a lower casing and an upper cover;
the outer member has a cross-sectional shape comprising a vertical part and a horizontal part, and forms a side surface of the lower casing; and
the horizontal part protrudes sideways from the lower casing.

12. The battery pack structure of claim 11, wherein the member reinforcement part is positioned in the horizontal part of the outer member.

13. The battery pack structure of claim 11, wherein the horizontal part of the outer member has mounting holes at locations spaced forwards and rearwards from the member reinforcement part, the mounting holes being configured to mount a battery pack to a vehicle body.

14. The battery pack structure of claim 11, wherein a front wall member is positioned at a front portion of the lower casing, the front wall member being connected to a front end of the outer member;
a rear wall member is positioned at a rear portion of the lower casing, the rear wall member being connected to a rear end of the outer member; and
the outer member has mounting holes at a location spaced apart from the member reinforcement part and adjacent to the front wall member, and at a location spaced apart from the member reinforcement part and adjacent to the rear wall member, and the mounting holes being configured to mount a battery pack to a vehicle body.

15. A battery pack structure of a vehicle, the battery pack structure comprising:
an outer member forming a side surface of a lower casing receiving a battery module;
a member reinforcement part formed by inserting a structural foam into a partial section of the outer member; and
mounting holes positioned on the outer member being spaced forwards and rearwards from the member reinforcement part, and configured to mount the lower casing to a vehicle body.

16. The battery pack structure of claim 15, further comprising:
a front wall member connected to a front end of the outer member, and surrounding a front portion of the lower casing; and
a rear wall member connected to a rear end of the outer member, and surrounding a rear portion of the lower casing;
wherein the member reinforcement part is positioned at a maximally spaced location from both of the front wall member and the rear wall member; and
wherein the mounting holes are positioned at locations adjacent to both of the front wall member and the rear wall member.

17. The battery pack structure of claim 15, wherein the outer member has a hollow cross section including a vertical part surrounding a side surface of the lower casing and a horizontal part protruding outwards from the vertical part, the vertical part and the horizontal part being integrated with each other; and
the member reinforcement part is positioned in the horizontal part of the outer member.

18. The battery pack structure of claim 17, wherein a partition plug is positioned in the horizontal part of the outer member and is configured to limit a flow range of the structural foam when the structural foam forming the member reinforcement part is injected.

19. The battery pack structure of claim 18, wherein the partition plug comprises:
a partition wall blocking a hollow part in the horizontal part configured to limit the flow range of the structural foam; and
a fixation rib integrally connected to the partition wall to fix the partition wall;
wherein a fastening bolt is fastened to the horizontal part of the outer member and configured to fix the fixation rib.

20. The battery pack structure of claim 19, wherein the partition plug has a cover part configured to cover a plug hole formed in the horizontal part, and to allow the partition wall and the fixation rib to be inserted.
